(19) United States
(12) Patent Application Publication
(10) Pub. No.: US 2002/0049601 A1
(43) Pub. Date: Apr. 25, 2002

(54) OPTIMISTIC FAIR EXCHANGE PROTOCOLS

(76) Inventors: NADARAJAH ASOKAN, RUESCHLIKON (SE); VICTOR SHOUP, ZURICH (SE); MICHAEL WAIDNER, RUESCHLIKON (SE)

Correspondence Address: McGinn & Gibb, PLLC, 8321 Old Courthouse Road, Suite 200, Vienna, VA, 22182-3817, US

(21) Appl. No.: 09/181,442

(22) Filed: Oct. 28, 1998

(51) Int. Cl. G06F 17/60

(52) U.S. Cl. 705/1

(57) ABSTRACT

A method for the fair exchange of value items between two parties is presented in which a third party is only involved in exceptional situations. Each party sends initially in an exchange procedure, to the other party a permit which binds its value item in such a way that the receiving party can verify the fact that the value item is bound, but cannot yet extract the expected value item from the permit. If a party can accept a permit as correct, it then sends the actual value item to the other party. Thus, the exchange can be completed without involving the third party if no exceptional situation occurs.

For exceptional situations, subprotocols are provided by which a party, if not satisfied, can involve the third party and send to it the permit previously received. The third party can then obtain the value item from the permit and could deliver it to the requesting party. However, the subprotocls are so designed that in any case, the exchange procedure is completed, and either both parties have received the value item expected, or none of both received a value item from the other party. This exchange method operates reliably even in netweorks with arbitrary latency.

### TECHNICAL FIELD

Present invention relates generally to the exchange of value items such as certified mail, electronic cash payment and receipt, or contract signatures over a network by electronic communication, and more particularly to protocols for the fair exchange of value items between two parties where a third party is available for executing auxiliary procedures when this is required.

### BACKGROUND

Many electronic commerce transactions are exchanges of items of value (hereafter referred to as “value items”). Exchanging a mail for a signed receipt (certified mail), exchanging non-repudiable commitments on a contract text (contract signing), exchanging electronic payment for a receipt etc. are examples of exchange transactions. Each party in an exchange will want to ensure that it does not suffer a loss of value. This property is known as “fairness.” A fair exchange guarantees that either both parties receive the value items they expect or neither does. The fairness property of exchange transactions is sometimes known also by other terms such as atomicity or simultaneity.

A straightforward way of guaranteeing fairness is to involve a trusted intermediary (also known as a trusted third party) in every exchange transaction. This approach suffers from two main disadvantages: a performance penalty incurred by having to involve a third party in every transaction, and the need to trust the third party to a great extent. Other approaches which do not involve a third party are expensive in terms of the number of messages sent and the rounds of communication required.

Various exchange protocols were already suggested, e.g. those described in following publications: (a) U.S. Pat. No. 5,666,420: S. Micali: “Simultaneous Electronic Transactions” (Sep. 1997). (b) N. Asokan, M. Schunter, M. Waidner: “Optimistic Protocols for Fair Exchange”; Proc. 4th ACM Conf. on Computer and Communication Security, Zurich, Apr. 1997, pp.6-17; (also: IBM Research Report RZ 2858, Sep.1996). (c) M. Ben-Or, O. Goldreich, S. Micali, R. L. Rivest: “A Fair Protocol for Signing Contracts”; IEEE Trans. on Information Theory, Vol.36 No.1 (1990), pp.40-46. (d) H. Buerk, A. Pfitzmann: “Value Exchange Systems Enabling Security and Unobservability”; Computers & Security, Vol.9 No.8 (1990), pp.715-721. Though the methods described in these publications may achieve a fair exchange of value items to a certain degree, they have some deficiencies in that they were either limited to particular applications, were not practicable in networks of arbitray latency, and all of them were applicable only for value items of specific structures. The listing of present invention's advantages which is given further below will refer also to some of the deficiencies of existing solutions.

### OBJECTS OF THE INVENTION

The invention has the following objects for a fair exchange protocol, to overcome disadvantages of previous solutions:

Optimism: no third party is used in the common case under the optimistic assumption that parties in the exchange behave correctly most of the time, while reserving the possibility of using a third party under exceptional, predetermined circumstances.

Timely completion in realistic networks: even in networks with arbitrary latency (i.e., networks in which messages sent are eventually delivered, but no guarantee is made about the amount of time required for delivery), each party should be able to conclude the exchange fairly even when the other party fails to follow the protocol correctly.

Generality: the protocol should be as general as possible, capable of exchanging a wide variety of value items.

Minimal trust: the protocol should minimize the trust placed on the third party.

### BRIEF SUMMARY OF THE INVENTION

Basically, the invention provides, in a method for the fair exchange of value items between two parties, in a network with arbitrary latency, the initial exchange of permits between the parties, where each permit binds a representation of an expected value item so that a receiving party can verify this fact but cannot obtain the value item directly from the permit, but where a third party, when receiving the permit and some security information, can obtain the representation of the value item for delivery to a requesting party; both parties initially exchange and verify permit, and in case of successful verifications, then the actual value items are exchanged. This procedure allows, in the majority of normal cases, a fair and secure value item exchange in a few steps without any participation of the third party. The invention provides additonal subprotocols by which each party can request the cooperation of the third party, by sending to it the permit previously received plus additional identifying information, so that the third party can resolve an exceptional situation without further cooperation of the two parties.

The invention has the following advantages:

It is a generic protocol for fair exchange, which can be used for specific fair exchanges like certified mail, contract signing, secure transaction commitment, and payment for receipt (the notion first described in (b) by Asokan, Schunter and Waidner; however, the solution described there did not achieve a strong degree of fairness. Solutions that did achieve stronger degrees of fairness, such as the method of Micali's patent (a), were not general —Micali's solution was limited to certified mail).

It is optimistic in that it involves a third party only under rare, predetermined circumstances (the contract signing protocol described by Ben-Or, Goldreich, Micali, and Rivest in (c) can be classified as optimistic because it specifies a third party to be used only under exceptional circumstances; the method described by Buerk and Pfitzmann in (d) was the first where optimism was explicitly intended as a design goal).

It is the first optimistic fair exchange protocol which works even in a realistic network with arbitrary latency (the methods described in (a) and (b) etc. do not have this property); in particular if either party in the protocol decides at any arbitrary time to conclude the protocol, it can do so even when the other party is unreachable (due to network failures) or uncooperative, as long as the first party can send a single message to the third party and eventually receive a response from it.

It allows two different verifiable encryption embodiments which

(a) are noninvasive, in that they enable the exchange of already existing types of value items, such as various types of digital signatures and electronic coins, without modification and do not dictate the format of value items (in the Micali patent

(a), certified mail receipts etc. must be of a specific, nonstandard form), and

(b) avoid the need to trust the third party with the contents of the value items being exchanged (i.e., the contents of the value items need not be revealed to the third party).

It allows an embodiment implementing a fair contract signing protocol in which the third party can be held accountable for certain types of misbehavior by collecting evidence that can be used to prove this misbehavior to a court in a subsequent dispute. (the certified mail protocol disclosed in the Micali US patent (a) does not have this type of accountability property; at the same time, it is invasive as well. Micali emphasizes the “invisibility of third party” property of his protocol. But invisibility without non-invasiveness is not useful. Our embodiments based on verifiable encryption do have the invisibility property; but more importantly, they are non-invasive.)

Glossary

The following are informal definitions to aid in the understanding of the description.

Group: A group is an algebraic structure consisting of a set of elements and a group operation with some specified properties. For example, the set of integers 0. p−1, where p is a prime number, is a group under the multiplication operation. For any integer n, the set of integers {0.n−1} is known as Zₙ. Z*ₙ denotes the group consisting of the set of positive integers in Zₙ that are relatively prime to n.

Homomorphism: A homomorphism is a function that maps an element of one group (say G₁) to an element in another group (G₂) in such a way that the results of the group operation are preserved. In other words, if a and b are elements of G₁ and G₂, “*” and “+” indicate the group operations in G₁ and G₂, respectively, and Θ( ) is a homomorphism from G₁ to G₂, then Θ(a*b)=Θ(a)+Θ(b). A surjective homomorphism is one such that the range of the homomorphism is the entire group G₂.

Zero-knowledge proof (ZKP): In a zero-knowledge proof of knowledge, a prover demonstrates knowledge of a secret to a verifier in such a way that the verifier learns nothing more about the secret from participating in the ZKP protocol than he knew earlier from the public information about the secret.

One-way function: A one-way function f( ) is a function such that given input x, it is easy to compute f(x), but the inverse function is hard (i.e., given y, finding x such that f(x)=y.) A one-way hash function is a one-way function that takes an arbitrary length input and produces a fixed length output. A collision-resistant one-way function is a one-way function f( ) with the property that it is infeasible to find some a and b such that f(a)=f(b). If f(x)=y, x is called a pre-image of y.

Adaptive attacks: In an adaptive attack against cryptographic schemes, the attacker repeats the following process: he sends requests to the software or hardware units implementing the scheme, observes the responses, and based on the responses constructs and sends more requests, with the aim of eventually breaking the scheme. This is the strongest type of attack.

RSA with OAE padding: RSA with OAE padding is a specific form of RSA encryption scheme which is believed to be resistant to adaptive attacks.

Cramer-Shoup encryption function: Encryption function in the new Cramer-Shoup cryptosystem which is provably resistant to adaptive attacks.

### LIST OF DRAWINGS

In the sequel, embodiments of the invention will be described with reference to the following drawings:

FIG. 1 is a diagram illustrating the basic main protocol, employing present invention for the fair exchange of value items between two parties;

FIG. 2 illustrates a first subprotocol by which a first party A which initiated an exchange, requests the third party to terminate the exchange procedure in an exceptional situation;

FIG. 3 illustrates a second subprotocol by which a second party B which responded to an exchange initiation, requests the third party T to complete the exchange procedure in particular situations; and

FIG. 4 illustrates a third subprotocol by which the first party A requests the third party T to complete the exchange procedure in particular situations.

### DETAILED DESCRIPTION

The basics of the invention is a generic protocol for optimistic fair exchange. This generic protocol can exchange a large class of items which have the following property: The third party must be able to generate the item even if the party that was supposed to send the item (the “sender” of the item) stops cooperating. We call such items “generatable items.” In order to generate an item, the third party must be given a “permit,” which must be created ahead of time by the sender of the item. The permit is essentially a promise from the sender to the recipient that if the recipient takes the permit to a specified third party, the latter can recover the item on behalf of the recipient with no further help from the sender.

The problem to solve is as follows. Two parties A and B, which do not trust each other, want to participate in an exchange with A sending item_{A} and B sending item_{B}. A wants the protocol to guarantee that if it fails to receive item_{B} then B must not receive any additional information about item_{A}. B has a similar requirement. Our generic protocol suite has a main protocol used in the normal case and three sub protocols used in case something goes wrong. The main protocol takes the following approach in the normal case:

A sends a permit to B promising to send item_{A}

If B is satisfied with the permit, it sends a permit to A promising to send item_{B}

If A is satisfied with the permit, it sends item_{A} to B

B sends item_{B} to A

If we assume A and B behave correctly and send the messages they are supposed to send, then executing the main protocol is sufficient for a successful fair exchange. The assumption is normally valid, resulting in an efficient fair exchange. However, one of the parties may misbehave or the network connection between the players may fail, resulting in an abnormal situation. The sub protocols (also called “recovery protocols”) are for recovering from abnormal situations. The permits exchanged in the initial part of the main protocol are used in the recovery protocols. We explain the protocols in more details shortly.

First we describe the properties that a permit should provide, and then describe in detail the generic optimistic fair exchange protocol for generatable items. Then we describe a example of fair exchange (contract signing) where permits are constructed using digital signatures.

Then we describe a technique called “verifiable encryption” which can be used to create permits for elements of a type of algebraic structures known as “groups.” We illustrate how verifiable encryption permits are used with the generic protocol described earlier. Then we describe two ways of concretely implementing verifiable encryption of group elements. Finally, we describe how to reduce various types of value items to group elements so that they can be exchanged using the techniques described so far.

Generatable Items and the Notion of Permits

We assume that each value item has a unique description. We define a “permit” as having the following properties.

there is an associated permit transportation protocol in which

the sender of the permit participates by invoking a procedure bind which takes the following inputs

a value item to be sent

description of the value item expected from the receiver (referred to below as “expectation”)

a special “authenticator” string (used later by the third party to identify the sender)

identifier of the third party to be used when necessary which produces a permit which tightly binds (see below) all this information together, sends it to the recipient and also locally outputs it,

the recipient of the permit participates by invoking a procedure verify which takes following inputs which are supposedly embedded in the permit

description of the value item

an item matching the expectation

the special “authenticator” string

identifier of the third party to be used when necessary and which receives the permit from the sender and verifies if it is in accordance with the inputs; if so it locally outputs the permit; otherwise it signals an error,

given a permit, no one other than the creator of the permit and the third party will be able to extract any information about the value item embedded in the permit.,

if the verify procedure successfully returns a permit, then the recipient is guaranteed that the third party can recover the value item using this permit without any further cooperation from the sender,

given a permit, the recipient cannot tamper with the permit in such a way to create a modified permit binding a different expectation or authenticator with the same embedded item, and

given a permit, the third party designated in the permit can extract each embedded object (the item and expectation of the sender, the special authenticator, and the identifier of the third party).

In some embodiments (see “verifiable encryption” below) the item is extracted from the permit itself. In other embodiments (e.g., the “contract signing” embodiment below), the permit merely indicates to the third party that it can create the item or extract it from somewhere else (e.g., a database maintained by the third party). The item generated by the third party is functionally equivalent to the sender's item (i.e., the one used to create the permit) but not necessarily identical. Functional equivalence of two items means that both items satisfy the same expectation.

Any item for which such a permit can be created is called a “generatable item.”

Optimistic Fair Exchange of Generatable Items

Now we describe a protocol for optimistic fair exchange of generatable items. It is executed between two players A and B, with A sending item_{A} and B sending item_{B}. A's expectation is desc_{B} (i.e., A expects that it will receive an item that matches description desc_{B}); similarly B's expectation is desc_{A}. We assume a one-way function f( ). Both players have already agreed on desc_{A}, desc_{B}, and the identity of the third party to be used (T) before beginning the fair exchange protocol (by means of some external negotiation protocol executed between A and B prior to starting the fair exchange protocol).

Main Protocol

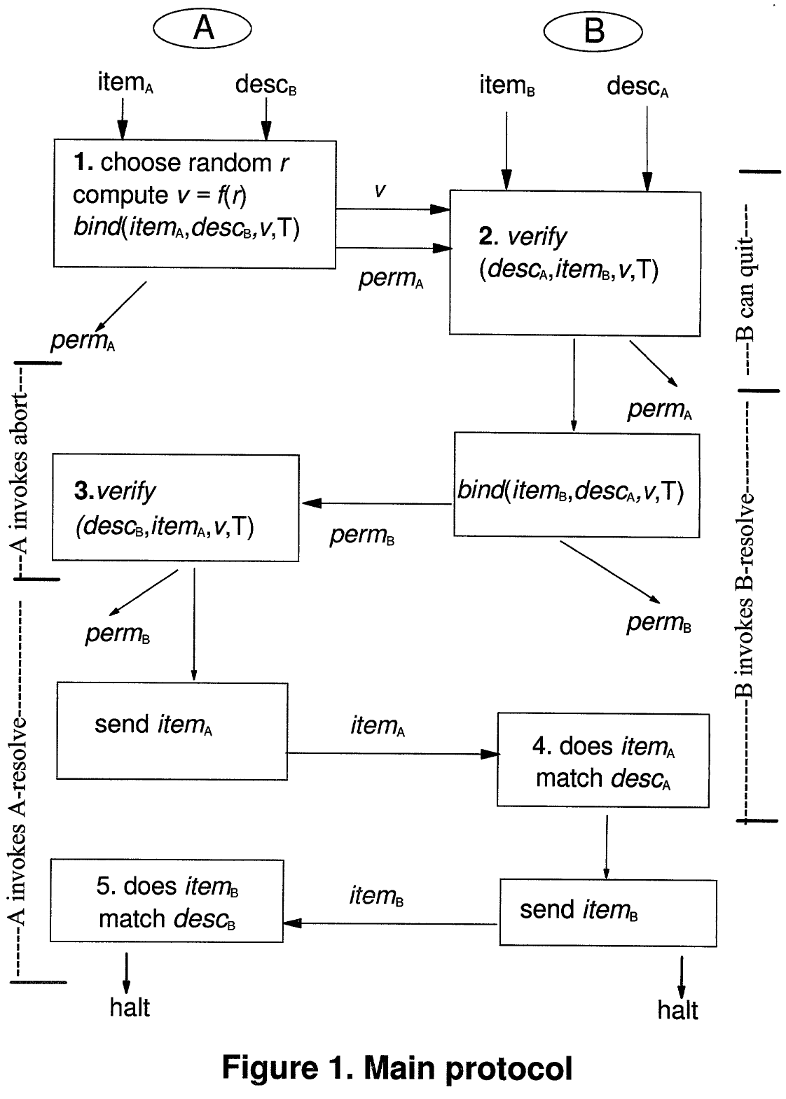

The main protocol is illustrated in FIG. 1. It includes following steps:

1. A does the following.

a. chooses a random string r from the domain of f( ) and computes an authenticator v=f(r).

b. sends v to B and runs the permit transfer protocol by invoking a procedure bind(item_{A},desc_{B},v,T) which constructs and sends perm_{A} to B and locally outputs a permit perm_{A}.

2. In the meantime, B receives v and participates in the permit transfer protocol by invoking a procedure verify(desc_{A},item_{B},v,T) which receives and verifies perm_{A}; if the verification succeeds, the permit is locally output; otherwise an error is signalled.

a. If the permit transfer protocols signals error, B halts. (*)(Meaning of asterisk is explained below.)

b. Otherwise B runs its own permit transfer protocol by invoking bind(item_{B},desc_{A},v,T) which constructs and sends perm_{B} to A and locally outputs a permit perm_{B}.

3. A participates in the permit transfer protocol by invoking a procedure verify(desc_{B},item_{A},v,T) which receives and verifies perm_{B}; if the verification succeeds, the permit is locally output; otherwise an error is signalled.

a. If the permit transfer protocols signals error, A invokes sub-protocol abort. (*)

b. Otherwise A sends item_{A} to B.

4. B verifies that item_{A} matches its expectation desc_{A}.

a. If the match fails, B invokes sub-protocol B-resolve. (*)

b. If the match succeeds, B sends item_{A} to A and halts.

5. A verifies that item_{B} matches its expectation desc_{B}.

a. If the match fails, A invokes sub-protocol A-resolve.(*)

b. If the match succeeds, A halts.

Each party may decide to give up at any stage, independently of the behavior of the other party. For example, either party may set up local timers whenever they start to wait for a message. If the timer runs out before the expected message is received, it can decide to give up. The steps above marked with ‘*’ (2a, 3a, 4a, and 5a) indicate the action to be taken on deciding to give up. For example, if A times-out while waiting for a reply after sending (step 1b) the first message from B, A will invoke sub-protocol abort (step 3a, which is the next step specifying an action for A marked with a ‘*’).

Recovery Protocols

The third party T maintains a database about exchange transactions it has dealt with so far. Note that this database will not contain information about those exchange transactions that were concluded successfully without involving T (i.e., the large majority of transactions). Transactions are identified by the authenticator strings embedded in the permits of a transaction. T handles each request atomically; in particular when T makes a read access to its database followed immediately by a write access in a given transaction, the pair of accesses are done atomically.

Sub-protocol Abort

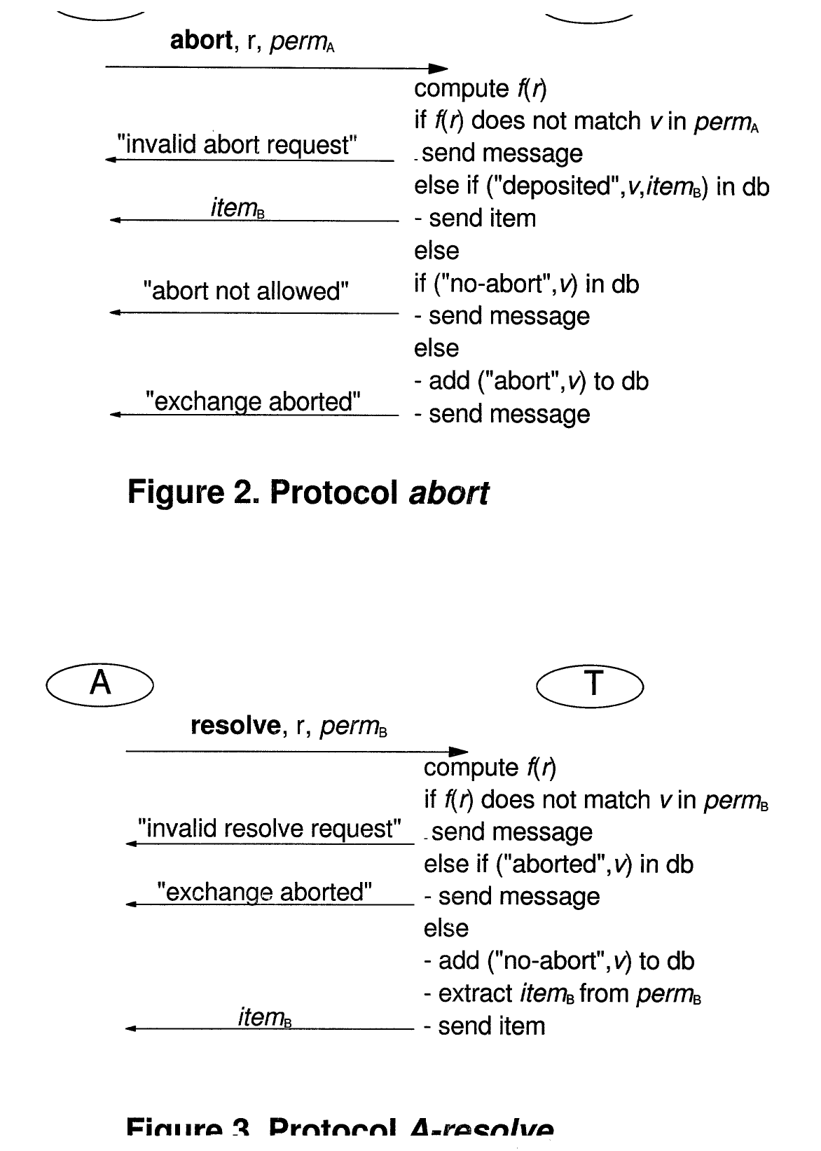

The subprotocol for requesting a termination is illustrated in FIG. 2. It includes following steps:

1. A sends an abort request with perm_{A} and r to T.

2. T checks to see if its database has an entry (“deposited”,f(r)), item_{B}); if there is one, T extracts the item embedded in item_{B} and returns it to A.

3. Otherwise, T checks to see if its database has an entry (“no-abort”,f(r)); if there is one, T sends an “abort not allowed” message to A.

4. Otherwise T atomically adds (“abort”,f(r)) to the database and sends an “exchange aborted” message to A.

Sub-protocol A-resolve

The resolving protocol for party A is illustrated in FIG. 3. It includes following steps:

1. A sends a resolve request with perm_{B} and r to T.

2. T extracts the authenticator v from perm_{A} and checks whether it is the same as f(r); if it is not, it sends an “invalid resolve request” message to A.

3. T checks to see if its database has an entry (“abort”,f(r)); if there is one, T sends an “exchange aborted” message to A.

4. Otherwise T atomically adds (“no-abort”,f(r)) to the database, extracts the item embedded in perm_{B} and returns it to A.

Sub-protocol B-resolve

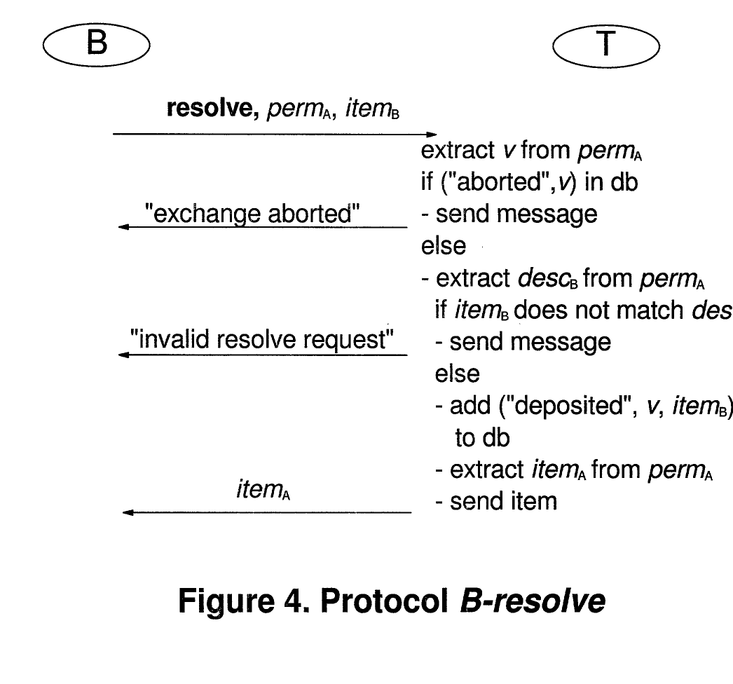

The resolving protocol for party B is illustrated in FIG. 4. It includes following steps:

1. B sends a resolve request with perm_{A}, and item_{B} to T.

2. T extracts the authenticator v from perm_{A} and checks to see if its database has an entry (“abort”, v); if there is, T sends an “exchange aborted” message to B.

3. Otherwise T checks to see if item_{B} matches the description embedded in perm_{A}; if it is not, T sends a “invalid resolve request” message to B.

4. Otherwise T adds a (“deposited”,v,item_{B}) entry to its database, extracts the item embedded in perm_{A} and returns it to B.

Variations

(a) The names A and B are not explicitly specified as input parameters to the procedures; this reflects our intention to be general enough to cover embodiments which allow A and B to remain mutually (as well as towards T) anonymous. But where necessary, the identifiers can be specified as part of the items and descriptions. Also, note that even when A and B are mutually anonymous, they need to use some sort of communication address to send protocol messages to each other. But these addresses are typically one-time addresses which are not related to the names.

(b) If A and B do not want T to learn the actual items being exchanged, they can first apply a mutually agreed upon conversion procedure to their respective value items and exchange only the modified value items. At the end of the exchange, the actual items can be recovered from the modified value items by applying an opposite recovery procedure. This way, T may only learn about the modified value items which can be constructed in a way so that they reveal no information about the actual value items. A trivial way to do this is for the sender to encrypt the item with the recipient's public key and using the result in the fair exchange protocol The discussion below about verifiable encryption in fact uses an embodiment with this property.

(c) In theory, the database records of T must be stored forever; in practice, T can announce a policy of expiring transaction records after a certain period of time.

Constructing Permits

There are various ways of implementing permits with the specified properties. The essential binding property can be provided by a secure cryptographic primitive which is resistant to adaptive attacks. Below, we outline two ways of constructing permits: a specific example using digital signatures, and a general method using a binding technique known as “verifiable encryption.”

Constructing Permits Using Digital Signatures: an Example

We illustrate the use of digital signatures to construct permits by considering a specific example of fair exchange: contract signing. The goal is for A and B to obtain each other's non-repudiable commitments on some previously agreed upon contract text, text.

The generic exchange protocol is instantiated as follows:

A's item is of the form item_{A}=Sig_{A}(A, B, text) (where Sig_{A} indicates a digital signature using A's signature key) and B's item is of the form item_{B}=Sig_{B}(A, B, text).

A's permit sent in the first flow is of the form perm_{A}=Sig_{A}(A, B, text, v, T). B's permit sent in the second flow is of the form perm_{B}=Sig_{B} (A, B, text, v, T). The contract text ‘text’ and the names of the players constitute the descriptions of the expected items as well as the item to be generated by T on presentation of a permit.

During the execution of either resolve protocol, T is presented with both permits perm_{A} and perm_{B}. If the permits are formed properly, T issues a replacement contract, of the form Sig_{T}(A, B, text, v, perm_{A}, perm_{B}).

During the abort protocol, T checks that the request is accompanied by a valid pre-image of v, and if so, issues an abort token of the form Sig_{T}(A, B, text, v, “abort”).

If an exchange is already aborted, then T should respond with the abort token to any subsequent resolve request for the same exchange; similarly, if an exchange is already resolved, T should respond with the replacement contract to any subsequent abort request for the same exchange.

A valid contract is either the pair (item_{A}, item_{B}) or the replacement contract. This protocol is therefore invasive, because we take the liberty of specifying the format of a valid contract. On the other hand, the two forms of a valid contract help make it clear if T was involved in resolving an exchange. The protocol requires that for any given exchange, T can either issue a replacement contract or an abort token but not both. Thus, if T misbehaves by sending an abort token to one player and a replacement contract to the other, and the player who received the replacement contract attempts to enforce it, then the other player can prove that T misbehaved by producing the abort token received. This makes T accountable with respect to this specific type of misbehavior.

Constructing Permits Using Verifiable Encryption

In the following, we focus on building permits using verifiable encryption and using them in the optimistic fair exchange protocol. In the next section, we show how to construct permits for elements of an algebraic group for which a suitable surjective group homomorphism exists. Quite often, value items in electronic commerce are represented by digital signatures, electronic coins, electronic checks etc. It is possible to reduce these value items to homomorphic inverses. Thus, if we can construct a fair exchange protocol to exchange group elements, we can use it to exchange more general value items as well. We return to this discussion later.

Suppose s is a secret element of a group G₁. Suppose further that there exists a surjective homomorphism Θ which maps a given element of group G₁ to to an element of group G₂. The description of s is d=Θ(s). If Θ is one-way, it is infeasible to compute s given d. We assume that the representation of d contains all the necessary information to describe the groups involved and how to compute the homomorphism.

A verifiable encryption scheme for such group elements is defined by a verifiable encryption protocol, and a corresponding decryption algorithm. In the verifiable encryption protocol,

a prover P participates by invoking a procedure VE which takes s|x (where s represents a value item and is an element of G₁, x is some arbitrary string, and “|” symbol indicates the encoding of two bitstrings to produce a new bitstring such that the original bitstrings can be recovered from the resulting bitstring; an example of such an encoding is concatenation), and

a verifier V participates by invoking a procedure VV with d|x as input which will output a valid verifiable encryption c of s|x if the prover had invoked VE with s|x.

The decryption algorithm takes a ciphertext c and a string x and return a plaintext s if c was constructed by a prover invoking VE with s|x as input.

Now we briefly describe how to use permits based on verifiable encryption in the optimistic fair exchange protocol. Suppose the value item of a participant P (which can be either A or B) in a fair exchange is an element s of group G₁. The other participant (V) in the exchange therefore already knows the description of this secret d=Θ(s). We choose a verifiable encryption scheme (see below for concrete embodiments) so that only T can decrypt verifiable encryptions.

When P invokes the bind procedure to construct and transfer the permit, it starts the verifiable encryption protocol with VE(s|desc_{V}|v|T), where desc_{V} and v are as described in the previous section. The string “desc_{V}|v|T” indicates the access conditions checked by T during abort/resolve protocols: recall that in the case of player A, T entertains abort/resolve requests only if A includes an authenticator r in its requests such that v=f(r); in the case of player B, T entertains a resolve request only if B includes an item that matches desc_{B}.

When V invokes the verify procedure to receive and verify the permit, it in turn invokes procedure VV(d|desc_{V}|v|T), which, if successful, results in a verifiable encryption being output. When T receives a permit of the form VE(s|desc_{V}|v|T) from V as part of a resolve request, it executes the procedure VD to decrypt the permit, perform the checks as mentioned in the previous sections, and if they succeed, return s to the requester.

Implementing Verifiable Encryption

First we describe two concrete techniques to implement verifiable encryption. We write the groups additively (i.e., group operations are indicated by the symbols + and −).

Verifiable Encryption with Off-line Coupons

First we describe a verifiable encryption scheme using “off-line” coupons which are constructed in advance. Recall that the goal is for the prover to produce a verifiable encryption c of a group element s concatenated with an arbitrary string b so that

the third party can recover s given c, and

the verifier who already knows d=Θ(s) can verify that c does in fact contain an encryption from which the VD procedure can recover s|b.

The procedure is as follows:

Preprocessing

T has a public-/private-key pair in some standard public key encryption system resistant against adaptive chosen ciphertext attacks (e.g., the Cramer-Shoup encryption algorithm or the RSA encryption algorithm with OAE padding). We use E( ) to denote encryption with T's public encryption key and D( ) to denote the corresponding decryption with T's private decryption key. To encrypt a message m, one would choose a random string t of a length specified by the encryption system and compute the ciphertext as E(t,m). T also has a public-/private-key pair in some standard digital signature scheme (e.g., DSS). All players possess authenticated copies of T's public keys.

During an initialization step, a player P sends a coupon request to T.

1. Upon receiving this request, T does the following:

a. generate a random element s′ in G₁ and compute d′=Θ(s′),

b. generate a new key-pair (PK,SK) for some digital signature scheme,

c. generate a random string t, and then a coupon coup of the form <d′, E(t, s′), PK> and sign it to produce a certificate cert, and

d. send the coupon and cert to P along with the signing key SK and the secret s′.

2. P stores the set of values received from T

P can request several such coupons at a time.

Verifiable Encryption

Later P wants to send a verifiable encryption of a group element s and some arbitrary string x to V. V already knows the description d=Θ(s). In procedure VE, P carries out the following steps:

P.1 choose one of the stored set of values containing <coup, cert, s′, SK>,

P.2 compute s″s+s′,

P.3 construct p=Sig_{SK} (E(t, s′)|x) (where “Sig_{SK}” indicates a digital signature with the SK as the signature key), and

P.4 send p, s″, the coupon coup and its certificate cert to V.

In procedure W, V carries out the following steps to receive and verify the encryption.

V.1 receive p, s″, the coupon coup and its certificate cert from P,

V.2 compute d″=Θ(s″), and check if it is the same as d+d′; if not, signal an error and quit,

V.3 otherwise verify each of the following steps; if any of the verifications fail, signal an error and quit:

a. verify, using T's signature verification key, that cert is a valid signature by T on coup,

b. verify, using PK, that p is a valid signature on E(t, s′)|x,

c. store s″ for use during recovery.

In procedure VD, T receives the verifiable encryption (consisting of p, the coupon coup and its certificate cert) as input and carries out the following steps to decrypt it:

T.1 verify each of the following steps; if any of the verifications fail, signal an error and quit:

a. verify, using T's signature verification key, that cert is a valid signature by T on coup, and

b. verify, using PK, that p is a valid signature on E(t, s′)|x,

T.2 if the access conditions encoded in the string x are met, decrypt E(t, s′) and output s′, otherwise signal an error and quit.

VD does not output the real secret s; but it can be recovered by combining s′ with the stored component s″ to produce s=s″−s′. Notice that this implies that when using this embodiment in the optimistic fair exchange protocol T (which executes procedure VD) gains no information about the value item s being exchanged. This avoids the need to trust T with the contents of the value items being exchanged.

Variations

The following variations are possible:

(a) In the preprocessing stage, the requester of coupons can generate s′ and the (PK, SK) pair on its own and send s′ and PK to be embedded into the coupon; in this case, T never learns the secret signature key SK.

(b) The use of one-time (PK,SK) pairs allow the participants' real identities to be hidden from each other as well as from T. When this anonymity is not necessary or possible, the requester could instead use its long term digital signature key pair.

(c) E( ) can be the encryption algorithm in a symmetric key encryption scheme, where the encryption/decryption key is known only to T.

(d) Instead of including an encryption of s′ in the coupon, T might store s′ on its database, and include only a reference to it in the coupon.

Varifiable Encryption with a Zero-knowledge Proof

The off-line coupon based scheme described above is very efficient but requires some preprocessing. Now we describe a verifiable encryption scheme using a zero-knowledge proof protocol which does not require any preprocessing, at the cost of a more expensive protocol in terms of sizes of messages exchanged between the two parties.

The scenario is as usual: P wants to send a verifiable encryption of a group element s and some arbitrary string x to V. V already knows the description d=Θ(s). In procedure VE, P begins with the following steps:

P.1 choose a random element s′ of group G₁, and compute d=Θ(s′),

P.2 compute s″=s+s′,

P.3 pick another random string t and compute p=E(t, s′|x), and

P.4 send p and d′ to V.

V begins procedure W with the following steps:

V.1 receive p, s′ from P,

V.2 randomly choose b as either 0 or 1 and send it to P.

P continues as follows:

P.5

a. if b=0, send s′ and t to V

b. if b=1, send s″.

V continues as follows:

V.3

a. if b=0, compute p′=E(t, s′|x) and check if p′ is the same as p; if not, signal an error and quit

b. if b=1, check if Θ(s″)−d is the same as d′; if not, signal an error and quit

c. otherwise, store p received earlier as a valid permit

If b=1, at the end of the procedure, V will have a verifiable encryption. This happens only 50% of the time since b is chosen randomly. However, the whole process is repeated N times (N=40 should be sufficient); since b is chosen randomly, it is unlikely that it will be 0 each time; consequently V will have a high probability of ending up with at least one usable verifiable encryption.

In procedure VD, T receives the verifiable encryption (consisting of p) and input and carries out the following steps to decrypt it:

T.1 decrypt p and extract the second component s′|x,

T.2 if the access conditions encoded in the string x are met, output s′ otherwise, signal an error and quit.

Variations

The following variations are possible:

(a) Instead of sending p in step P.4 above, P might apply a collision-resistant one-way hash function h( ) and send the resulting commitment h(p) to V. Later, if V chooses b=1, P can send p.

This will reduce the overall communication complexity. It can be reduced even further by combining the commitments of all N initial permits into a single hash.

(b) A standard technique to convert interactive proof protocols into non-interactive ones is to compute the challenge b as a hash of other parameters. In this case, N should be increased to about 80.

Reduction Procedures

As mentioned before, various types of common value items can be reduced to homomorphic inverses. Thus, these value items can be exchanged using the techniques described so far by first reducing them to group elements, then exchanging group elements as described, and finally recovering the value items from the exchanged group elements by a reverse reduction.

Consider a digital signature scheme. Suppose PK is a verification key in the scheme, with a corresponding signing key SK. Suppose the signature of a message m using the signing key SK under this signature scheme is σ.

A generic reduction scheme to reduce the signature scheme to a group homomorphism Θ which maps elements of G₁ to G₂ consists of:

a reduction algorithm which takes PK, m, and σ, and outputs an element s of G₁, an element d of G₂ such that d=Θ(s) and a string c

a verification algorithm which takes PK, m, d, and c as input and outputs “accepted” if c and d were part of the output of running a reduction algorithm with PK, m, and a valid signature on m with respect to PK, as input.

a recovery algorithm which takes PK, m, c, and s as inputs and outputs a string σ′ as output where σ′ will be a valid signature on m with respect to PK, if c and s were part of the output of running the reduction algorithm with PK, m, and a valid signature on m with respect to PK, as input.

RSA Signature Scheme

Reduction for the RSA signature scheme is straightforward. Here, the public key consists of a number n which is the product of two prime numbers p and q and a number e which is relatively prime to (p−1)(q−1); the private key is a number k such that e.k−1 mod (p−1)(q−1). The signature on a message m is typically computed by applying a one-way hash function h( ) to m to produce a hash and raising the result to its kth exponent: i.e., σ=h(m)^{k} mod n.

The homomorphic inverse operation is the e-th root finding. The group involved is Zₙ. The group operation is multiplication modulo n. The reduction algorithm takes (n,e), m, and σ=h(m)^{k} mod n as input and outputs, s=σ, d=h(m), and nothing for c. The verification algorithm takes (n,e), m, d=h(m) as input and outputs “accepted” if d is the same as h(m). The recovery algorithm simply returns σ.

Reduction for Other Schemes

Various other schemes can be reduced to a group homomorphism Θ to make them easily suitable for the fair exchange protocol of present invention. Such schemes include e.g.

the DSS signature scheme;

the Schnorr signature scheme; or

Stefan Brands' scheme for anonymous off-line electronic coins.

For more details on these reduction techniques, see N. Asokan, V. Shoup, M. Waidner: Optimistic Fair Exchange of Digital Signatures; IBM Research Report RZ 2973.

1. A method for the fair exchange of value items such as certified mail, electronic cash payment and receipt, or contract signatures, between two parties (A, B) in a network of arbitrary latency, according to a given protocol, in which method one party (A) receives the value item (item_{B}) of an other party (B) only if said other party also receives the value item (item_{A}) of said one party, and in which method a third party (T) is only involved in the exchange in exceptional situations;
providing an exchange protocol using permits each of which binds a representation of a value item such that:
a receiving party (A or B) can verify that the permit binds the representation of an expected value item but cannot obtain said expected value item from the permit, and
the third party (T), when receiving the permit and some additional information, can obtain the bound representation of the value item from the permit for delivery to one of the parties, without further cooperation of the two parties;
the protocol including steps for:
first sending a permit from each of the two parties to the other one for verification, and then
transmitting a representation of a value item from each party to the respective other party if the verification of a previously received permit was satisfactory for the transmitting party;
the protocol further providing:
at least one subprotocol (ABORT; A-RESOLVE; B-RESOLVE) for recovering from an exceptional situation; a subprotocol being invoked by one (A or B) of the two parties for involving the third party (T), and including the transmission of a permit and additional information from said one party to the third party;
the execution of a subprotocol, without further cooperation from any of the two parties, either completing the exchange procedure so that finally each correctly behaving party received a representation of the value item it expected from the respective other party, or terminating the exchange procedure so that none of the parties received the value item it expected from the respective other party.

2. A method in accordance with claim 1, in which
any one of the two parties (A, B) can invoke a subprotocol when either the verification by said one party of a permit received from the respective other party is unsatisfactory, or when said one party decides to invoke a subprotocol in a particular situation predetermined by the protocol.

3. A method in accordance with claim 1, in which the following three subprotocols are provided:
a) a first subprotocol (ABORT) for requesting the termination of an ongoing exchange procedure by the party (A) which initiated the exchange procedure;
b) a second subprotocol (B-RESOLVE) for requesting, by the party (B) which responded to the initiated exchange procedure, the third party (T) to resolve an exceptional situation by completing the exchange procedure using a received permit; and
c) a third subprotocol (A-RESOLVE) for requesting, by the party (A) which initiated the exchange procedure, the third party (T) to resolve an exceptional situation by completing the exchange procedure using a received permit.

4. A method for the fair exchange of value items such as certified mail, electronic cash payment and receipt, or contract signatures, between two parties (A, B) in a network of arbitrary latency, according to a given protocol, in which method one party (A) receives the value item (item_{B}) of an other party (B) only if said other party also receives the value item (item_{A}) of said one party, and in which method a third party (T) is only involved in the exchange in exceptional situations;
comprising the following steps for the exchange of a first value item (item_{A}) and a second value item (item_{B}) item between a first party (A) and a second party (B):
a) constructing by the first party (A), using a predetermined binding procedure, a first permit (perm_{A}) binding at least the first value item (item_{A}) and an authenticator (v); and sending the first permit (perm_{A}) and the authenticator (v) to the second party;
b) verifying by the second party (B), using a predetermined verification procedure, the received first permit (perm_{A}), and
if the verification fails, halting its operation, or
if the verification succeeds, constructing a second permit (perm_{B}) binding at least the second value item (item_{B}) and the authenticator (v), and sending the second permit to the first party (A);
c) verifying, by the first party, the received second permit (perm_{B}), and
if the verification fails, invoking a first subprotocol (ABORT) for requesting a termination of the exchange procedure, or
if the verification succeeds, sending the first value item (item_{A}) to the second party;
d) verifying, by the second party, whether the received first value item matches its expectation (desc_{A}), and
if the verification fails, invoking a second subprotocol (B-RESOLVE) sending the received first permit (perm_{A}) to the third party (T) and requesting it to resolve the situation, or
if the verification succeeds, sending the second value item (item_{B}) to the first party and halting its operation;
e) verifying, by the first party, whether the received second value item matches its expectation (desc_{B}), and
if the verification fails, invoking a third subprotocol (A-RESOLVE) sending the received second permit (perm_{B}) to the third party and requesting it to resolve the situation, or
if the verification succeeds, halting its operation.

5. A method in accordance with claim 4, in which
the execution of a subprotocol, without further cooperation from any of the two parties, either completes the exchange procedure so that finally each correctly behaving party received the value item it expected from the respective other party, or terminates the exchange procedure so that none of the parties received the value item it expected from the respective other party.

6. A method in accordance with claim 4, in which
any one of the two parties (A, B) can invoke a subprotocol when either the verification by said one party of a permit received from the respective other party is unsatisfactory, or when said one party decides to invoke a subprotocol in a particular situation predetermined by the protocol.

7. A method in accordance with claim 4, in which each of the constructed permits (p) binds the following items:
the value item (e.g. item_{A}) which the respective party (e.g. A) will provide;
a description of the value item (desc_{B}) which is expected from the other party (B);
the authenticator for the respective exchange procedure (v); and
the identifier for the third party (T).

8. A method in accordance with claim 4, in which
the first party (A) computes the authenticator (v) to be used according to v=f(r), using a predetermined one-way function f( ) and a random string r, so that r is a pre-image of v with respect to the function f( ).

9. A method in accordance witch claim 8, in which
for invoking the first subprotocol (ABORT) or the third subprotocol (A-RESOLVE), the first party sends to the third party (T), besides the permit, additional information related to the authenticator (v), so that the third party can identify the respective exchange procedure, and verify that the invoking party was in fact the initiator of the exchange.

10. A method in accordance with claim 4, in which a first subprotocol (ABORT) for requesting the termination of an ongoing exchange procedure is provided which includes the following steps:
a) sending, by the first party (A), an abort request to the third party (T) including the first permit (perm_{A});
b) executing, by the third party, one of the following operations:
b1) sending to the first party a representation of the second value item (item_{B}) if it previously received and stored said representation of the second value item; otherwise
b2) sending to the first party a message preventing an abort operation, if a respective entry [to prevent an abort] was previously entered into its storage; otherwise
b3) sending to the first party a message that the exchange is aborted, and entering a respective entry into its storage.

11. A method in accordance with claim 8 and claim 10 in which
the first party includes in the abort request, besides the first permit, the pre-image r of the authenticator; and
the third party computes f(r) and checks whether the result corresponds to the authenticator (v) included in the received first permit (perm_{A}), prior to executing one of the conditonal steps b1, b2, or b3.

12. A method in accordance with claim 4, in which a second subprotocol (B-RESOLVE) for requesting a resolving operation from an exceptional situation in an exchange procedure is provided which includes the following steps:
a) sending, by the second party (B), a resolve request to the third party (T) including the first permit (perm_{A}) and a representation of the second value item (item_{B});
b) executing, by the third party, one of the following operations:
b1) extracting the authenticator (v) from the first permit (perm_{A}) for locating a respective_entry, and if it finds an entry in its storage that the exchange was aborted, sending a respective message to the second party; otherwise
b2) checking whether the received representation of the second value item matches a description (desc_{B}) of an expected value item included in the first permit (perm_{A}) and, if the check fails, sending a message to the second party that the resolve request is invalid; otherwise
b3) entering the received second value item (item_{B}) into its storage, and extracting the representation of the first value item (item_{A}) from the first permit (perm_{A}) and sending it to the second party.

13. A method in accordance with claim 4, in which a third subprotocol (A-RESOLVE) for requesting a resolving operation from an exceptional situation in an exchange procedure is provided which includes the following steps:
a) sending, by the first party (A), a resolve request to the third party (T) including the second permit (perm_{B});and
b) executing, by the third party, one of the following operations:
b1) sending to the first party a message that the exchange was aborted if it finds a respective entry in its storage; otherwise
b2) extracting the representation of the second value item (item_{B}) from the second permit (perm_{B}) and sending it to the first party, and entering an entry into its storage that an abort operation is not allowed.

14. A method in accordance witch claim 8 and claim 13, in which
the first party includes in the resolve request, besides the second permit, the pre-image r of the authenticator; and
the third party computes f(r) and checks whether the result corresponds to the authenticator (v) included in the received second permit (perm_{B}), prior to executing one of the conditonal steps b1 or b2.

15. A method in accordance with claim 1 or claim 4, in which each permit is constructed by a party (A or B) according to a predetermined procedure (BIND) for binding the following items:
a) a representation of a value item (item_{A}) of the respective party (A);
b) a description of the expected value item (item_{B}) of the other party (B);
c) an authenticator (v) identifying the particular exchange procedure, initially generated by the party (A) which started the exchange operation; and
d) an identification of third the party (T) to be involved in an exceptional situation.

16. A method in accordance with claim 1 or claim 4, in which
descriptions of the value items (desc_{A}; desc_{B}) expected by each of the two parties are exchanged between the parties prior to execution of the fair exchange protocol.

17. A method in accordance with claim 1 or claim 4, in which
the description (desc_{A}; desc_{B}) of an expected value item (item_{A}; item_{B}) which is a member of a first algebraic group (G₁) or which is converted to be represented by a member of a first algebraic group (G₁), is given as a member of another algebraic group (G₂) obtained by a homomorphic operation.

18. A method in accordance with claim 1 or claim 4, in which at least one of the permits is constructed by one of the two parties as a digital signature Sig_{X} under the signature key X of the respective party, binding at least the value item of said party (item_{X}), an authenticator (v) for the respective exchange operation, and an identifier for the third party (T) to be involved in exceptional situations.

19. A method in accordance with claim 1 or claim 4, in which at least one of the permits is constructed using a verifiable encryption protocol wherein:
a) a value item is represented as a selected member s of a first algebraic group G₁,
b) a description d of said selected member s, which description is a member of another algebraic group G₂ is generated by a homomorphic operation;
c) a permit is constructed by a proving party (P) by combining the selected member s with a bit string x which represents additional items (e.g. desc_{V}, v, T) required for execution of the exchange protocol, and encrypting the result using a predetermined encryption algorithm (VE);
d) the proving party (P) sends the resulting encryption as ciphertext c to the other, verifying party (V);
e) the receiving, verifying party (V) uses a verification algorithm (VV) corresponding to the predetermined encryption algorithm (VE), to obtain a verification ciphertext, using as input the description d previously obtained combined with said bit string x, so that the received ciphertext c corresponds to the locally generated verification ciphertext if the correct inputs were used by the prover and the verifier.

20. A method in accordance with claim 19, in which
said bit string x is a combination of a description (desc_{V}) of the value item expected from the verifying party (V), the authenticator (v), and the identifier (T) of the third party.

21. A method in accordance with claim 1 or claim 19, in which
coupons are used for the construction of verifiable encryption based permits, where each coupon is a security item which is independent of the value item for which a respective permit is constructed;
coupons are obtained prior to an actual exchange procedure in a pre-processing interaction between a proving party and the third party.

22. A method in accordance with claim 21, in which a proving party (P) wants to send to a verifying party (V) as permit (p) a verifiable encryption of a value item or secret s and an arbitrary string x; and the verifying party already knows the description d=Θ(s) of the value item or secret s of the proving party;
each coupon being prepared off-line in cooperation between the proving party (P) and the third party (T) executing following steps:
a) selecting a key pair (PK, SK) for a digital signature scheme, and a random element s′ as secret from an algebraic group G₁;
b) computing a description d′=Θ(s′) which is an element of an algebraic group G₂ in a homomorphic operation;
c) generating, by the third party
a coupon (coup) including d′, a random string t, s′, and PK; and
a certificate (cert) by signing the coupon;
and sending the coupon, the certificate, the signing key SK and the secret s′ from the third party to said proving party;
so that the proving party (P) can use a coupon and the corresponding certificate and signature key and the secret s′ to generate a permit (p) binding the value item s for a value exchange operation, and
so that a verifying party (V) when receiving the permit (p) and the corresponding coupon and certificate and certain additional information can verify the permit.

23. A method in accordance with claim 22, in which
said coupon (coup) generated by the third party (T) has the form of <d′, E(t,s′), PK> wherein t is a random string selected by the third party, and E(t,s′) is a ciphertext generated by a specified encryption system.

24. A method in accordance with claim 1 or claim 19, in which
verifiable encryption based permits are constructed without prior interaction between a proving party (P) and the third party (T), and
zero-knowledge proof procedures are used for the verifiable encryption and verification of permits.

25. A method in accordance with claim 22, in which a proving party, for sending a verifiable encryption of an item s to a verifying party, executes the following steps in the encryption procedure (VE):
choosing a stored coupon (coup) and following associated values: s′, SK, and certificate (cert);
computing s″=s+s′;
constructing the permit according to p=Sig_{SK}(E(t,s′)|x) where Sig_{SK} indicates a digital signature with SK as the signature key; and
sending the permit p, the coupon (coup), the value s″, and the associated certificate (cert) to the verifying party (V).

26. A method in accordance with claim 25, in which the verifying party (V) executes a verification procedure (VV) including following steps:
receiving the permit p, s″, the coupon (coup) and its certificate (cert) from the proving party (P);
computing d″=Θ(s″) and checking whether it is the same as d+d″; if not, signalling an error and quitting the procedure;
verifying, using T's signature verification key, that the certificate (cert) is a valid signature by T on the coupon (coup); and verifying, using PK, that the permit p is a valid signature on E(t,s′)|x; if any of these verifications fails, signalling an error and quitting the procedure;
if no error was signalled, storing s″ for use during recovery.

27. A method in accordance with claim 24, in which a proving party (P) wants to send to a verifying party (V) as permit (p) a verifiable encryption of a value item or secret s and an arbitrary string x, and the verifying party already knows the description d=Θ(s) of the value item or secret s of the proving party;
the method including following steps executed by the proving party (P) for the encryption procedure (VE):
a) choosing a random element s′ of said group G₁ and computing d′=Θ(s′);
b) computing s″=s+s′;
c) selecting a random string t and computing the permit p=E(t,s′|x); and
d) sending the permit p and the description d′ to the verifying party (V).

28. A method in accordance with claim 27, including the following steps for the verification procedure (VV):
a) by the verifying party:
randomly choosing a binary variable as either 0 or 1, and sending the chosen value to the proving p
b) by the proving party:
b1) if b=0, then sending s′ and t to the verifying party; or
b2) if b=1, then sending s″ to the verifying party;
c) by the verifying party:
c1) if b=0, computing p′=E(t, s′|x) and checking whether p′ is the same as the received permit p; if not, signalling an error and quitting the process; or
c2) if b=1, checking whether Θ(s″)−d is the same as d′; if not, signalling an error and quitting the process; otherwise storing the received permit p as a valid permit, along with the corresponding s.

29. A method in accordance with claim 28, in which
the verifying procedure (VV) is repeated a predetermined number of times (N), and
one of the stored valid permits p is selected as the permit to be used by the verifying party in recovery subprotocols.

30. A method in accordance with claim 1 or claim 4, in which
common value items (electronic coins, digital signatures) are reduced to homomorphic inverses in suitable algebraic groups, prior to an exchange procedure.
